(19) United States
(12) Patent Application Publication
(10) Pub. No.: US 2019/0058343 A1
(43) Pub. Date: Feb. 21, 2019

(54) CHARGER SYSTEM AND POWER ADAPTER THEREOF

(71) Applicant: Gemi Semiconductor Inc., New Taipei City (TW)

(72) Inventor: Kwang-Hwa Liu, New Taipei City (TW)

(73) Assignee: Gemi Semiconductor Inc., New Taipei City (TW)

(21) Appl. No.: 15/682,562

(22) Filed: Aug. 22, 2017

(30) Foreign Application Priority Data
Aug. 18, 2017 (TW) 106128186

(51) Int. Cl. H02J 7/00; H02M 3/335; H02M 1/08

(52) U.S. Cl. CPC H02J 7/0052; H02M 2001/0009; H02M 1/08; H02M 3/33507

(57) ABSTRACT

A charger system which includes a power adapter, an enhanced USB cable and a linear charger. The power adapter includes a two-way voltage divider. The two-way voltage divider receives a reference voltage through a first end and divides the reference to generate a default voltage level, or additionally receives a current request signal through a second end. The enhanced USB cable is coupled to the power adapter for transmitting the adapter output voltage. The linear charger is coupled to the transmission cable to receive the adapter output voltage. Wherein, the power adapter identifies whether the enhanced USB cable is a compliant cable or not, and identifies whether the charger is a compliant charger or not according to the presence of a current request signal. Wherein, the power adapter folds back the output voltage at a current limit level according to the charger current request signal.

### CROSS-REFERENCE TO RELATED APPLICATION

This application claims the priority benefit of Taiwan application serial no. 106128186, filed on Aug. 18, 2017. The entirety of the above-mentioned patent application is hereby incorporated by reference herein and made a part of this specification.

### BACKGROUND

### Field of the Invention

The invention relates to a linear type charger system and a power adapter thereof. Particularly, the invention relates to the charger system and the power adapter for improving charging efficiency.

### Description of Related Art

Most mobile phones today use a linear type charger system, which includes a 5.0V, 1.0 A power source, a USB cable, and an internal linear charger (ILC). The power source can be a USB data port (known as a Standard Down-stream Port), or an AC/DC adapter. The ILC further includes a power MOSFET. By controlling the gate-source voltage of the power MOSFET, the ILC can regulate the charging current or charging voltage during four stages of a charging process. The main advantages of using a linear charger are its circuit simplicity and low cost of circuit implementation. Further, unlike a switching mode charger, a linear charger does not require any inductor or transformer components. Hence, the linear charger can be implemented in a monolithic integrated circuit (IC). In fact, the majority of mobile phones before year 2014 use an internal linear charger with a 1.0 A maximum charging rate.

However, with the advent of 4G networks, the mobile phone market has entered the smart phone era. With the introduction of first smart phones using the Android operating system, and the introduction of iPhone 4 by Apple Inc., both happened in 2010, the smart phones have gained wide-spread popularity and started to dominate the mobile phone market. In the period from 2008 to 2016, the average battery capacity of a mobile phone had improved from about 900 mAH to roughly 3200 mAH. While the previous standard 5V, 1 A adapter can recharge an empty 900 mAH battery to 90% capacity in about one hour, it takes over 3 hours for the same adapter to recharge an empty battery.

Please refer to FIG. 1, which illustrates a block diagram of a conventional charger system. The charger system 100 includes a conventional adapter 110, a standard universal serial bus (USB) cable 120, a charger controller 130, and a transistor (MOSFET) Q1. The adapter 110 has output ends VO+ and VO− for transporting an output voltage Vout. The standard USB cable includes a power wire 121, a ground wire 122, a first data transmission wire, and a second data transmission wire. The DC resistance of the power wire and the ground wire is in the order of 0.25Ω each. The charger system 100 is used to charge a battery BAT coupled to the transistor Q1. Please also refer to FIG. 2A and FIG. 2B, which illustrate waveforms of operations of the conventional charger system.

In FIG. 2A, the adapter 110 is a 5V, 1 A adapter and used for charging a 1 A battery. Assume a charging process starts with a battery voltage, Vbat, of 3.0V, the charging process enters a constant current (CC) stage at time 0. A curve 213 shows the output voltage Vout is maintained by the adapter 110 at a constant level of 5.0V throughout the charging process. A curve 214 shows the Vin voltage received by the charger controller 130. In the CC stage (from time 0 min. to 40 min.), the charging current to the battery BAT can be regulated to 0.9 A. Since the total power-loop resistance, Rcb, of the power wire 121 and the ground wire 122 of the USB cable 120 is 0.5 (0.25+0.25) ohm, the voltage drop caused by the cable resistance Rcb equals to 0.45V during the CC stage. Hence, the curve 214, which shows the Vin voltage, is at 4.55V during the CC stage. On the other hand, curve 215 shows the Vbat voltage starts at 3.0V, gradually rises toward 4.2V during the CC stage. During the CC stage, the difference between the voltages Vin and Vbat is absorbed by the transistor Q1, which is operating in a linear mode. Hence, the drain-source voltage of the transistor Q1, a voltage Vds, is determined as, Vds=Vout−Ich*Rcb−Vbat, where Rcb is power-loop resistance of the USB cable 120. The power dissipation Pd of the transistor Q1, is the product of Ich and Vds, that is, Pd=Ich*Vds=Ich*(Vout−Ich*Rcb−Vbat). Where Ich is the current flowing through the USB cable 120.

A curve 216 shows the charging current Ich, which is maintained at 0.9 A throughout the CC stage. A curve 217 shows the transistor Q1 dissipation is 1.395 W at the start of CC stage, where the Vbat voltage is at 3.0V, and the Vds voltage is 1.55V. At the end of the CC stage, the Vbat voltage reaches 4.2V; whereas the Vds voltage drops to 0.35V. Dissipation of the transistor Q1 drops to 0.315 W at the end of the CC stage.

After the Vbat voltage reaches 4.2V, the charging process enters a constant voltage (CV) stage, where the Vbat voltage is regulated at a constant level of 4.2V. The charging current starts to taper off. However, due the decreasing cable voltage drop (=Ich*0.5 ohm), the Vds voltage is actually increasing during the CV stage. At the end of the CV stage, the current Ich drops to C/10 or (0.1 A) rate. At that moment, the charge controller 130 terminates the charging process. During the CV stage, dissipation of the transistor Q1 decreases from 0.315 W to 0.08 W.

In FIG. 2B, the adapter 110 is a 5V, 3 A adapter and used for charging a 3 AH battery BAT. The charging process begins at the voltage Vbat=3.0V. A curve 223 shows the Vout voltage, which is maintained by the adapter 110, at 5.0V. A curve 224 shows the Vin voltage trajectory. The Vin voltage is determined as: Vin=Vout−Ich*0.5 ohm. The cable loss of the USB cable 120 is equal to 3 A*0.5 ohm=1.5V, hence Vin=3.5V at the first 20 minutes of the CC stage. But as shown by the curve 225, as the Vbat voltage increases to 3.35V, the difference Vout and Vin drops below 1.5V, therefore not sufficient to support 3 A of charging current. As a result, and as shown in the curve 226, the Ich current starts to decrease as the Vbat voltage gradually increases toward 4.2V.

As the Vbat voltage reaches 4.2V at about the 60-minute mark, the charging current is reduced to Ich=(Vout−Vin)/0.5 ohm=0.65V/0.5 ohm=1.3 A. A curve 227 shows dissipation of the transistor Q1 is at the maximum value of 1.5 W at the start of the CC stage. But it drops to 0.45 W at the 20-minute mark; and further drops to 0.195 W at the end of the CC stage. But the heat dissipation by the USB cable 120 is 0.5 ohm*(3A)²=4.5 W at the first 20 minutes of the CC stage. A 4.5 W loss may result in a noticeable temperature rise on the USB cable 120, causing concern to the users.

Further, although both adapter 110 and charger controller 130 are capable of operating at 3 A charging current level, the high resistance (0.5 ohm) USB cable 120 limits the average CC stage charging current to about 2.2 A, well below the targeted 1 C (i.e. 3 A) rate.

### SUMMARY OF THE INVENTION

The invention is directed to a power adapter and a linear type charger system, where the power adapter is designed to minimize the heat dissipation on the power transistor of the charger.

The present disclosure provides a power adapter which includes a power converter and a feedback control circuit. The power converter receives an input voltage, performs a voltage converting operation on the input voltage to generate an output voltage according to an operating error voltage. The feedback control circuit includes a current reference processing circuit, a voltage loop circuit and a current loop circuit. The current reference processing circuit receives a current request signal and compares the current request signal with a plurality of setting voltages to generate a reference current signal. The voltage loop circuit generates a first error voltage according to a divided output voltage and a first reference voltage. The current loop circuit generates a second error voltage according to an output current signal from the power converter and the reference current signal. Wherein, the operating error voltage is set to be equal to the first error voltage or the second error voltage, whichever has a lower voltage level.

The present invention provides a charger system which includes a power adapter as mentioned above, an enhanced USB cable, and a charger. The power adapter includes a two-way voltage divider. The two-way voltage divider receives a reference voltage through a first end and dividing the reference voltage to generate a default voltage level, or additionally, receives a current request signal through a second end. The enhanced USB cable is coupled to the power adapter for transmitting the adapter's output voltage. The charger is coupled to the transmission cable to receive the output voltage. Wherein, the power adapter identifies whether the enhanced USB cable is a compliant cable or not, and identifies whether the charger is a compliant charger or not according to the presence of a current request signal.

In an embodiment of the present disclosure, the transmission cable is a compliant high-current USB cable whose power wire and ground wire have a lower DC resistance in the order of 0.05Ω each. Furthermore, this compliant high-current USB cable includes a bridging resistor, which is coupled between the first data transmission wire and the second data transmission wire.

In an embodiment of the present disclosure, the charger includes a multiplexer circuit, a comparing circuit and a control logic circuit. The multiplexer circuit is coupled to the first data transmission wire, and selects one of a plurality of request voltages to generate the current request signal according to a control signal. The comparing circuit is coupled to the second data transmission wire, receives a default voltage level on the second data transmission wire, and compares the default voltage level on the second data transmission wire with a plurality of threshold voltages to generate a detection signal. The control logic circuit is coupled to the comparing circuit and the multiplexer circuit, and generates the control signal according to the detection signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention.

FIG. 1 illustrates a block diagram of a conventional charger system.

FIG. 2A and FIG. 2B illustrate waveforms of operation of the conventional charger system.

FIG. 3 illustrates a schematic diagram of a charger system according to an embodiment of the present disclosure.

FIG. 4A and FIG. 4B illustrate characteristics of the power adapter according to an embodiment of the present disclosure.

FIG. 5 illustrates a schematic diagram of a power adapter according to an embodiment of the present disclosure.

FIG. 6 illustrates a schematic diagram of a charger according to an embodiment of the present disclosure.

FIG. 7A and FIG. 7B illustrate waveform plots of the charger system according to an embodiment of the present disclosure.

FIG. 8 shows the flowchart of operation of a charger system according to an embodiment of the present disclosure.

FIG. 9 shows the power source identification routine of the step S803 according to the embodiment in FIG. 8 of the present disclosure.

FIG. 10 shows the CPS reaction to the step S804 according to the embodiment in FIG. 8 of the present disclosure.

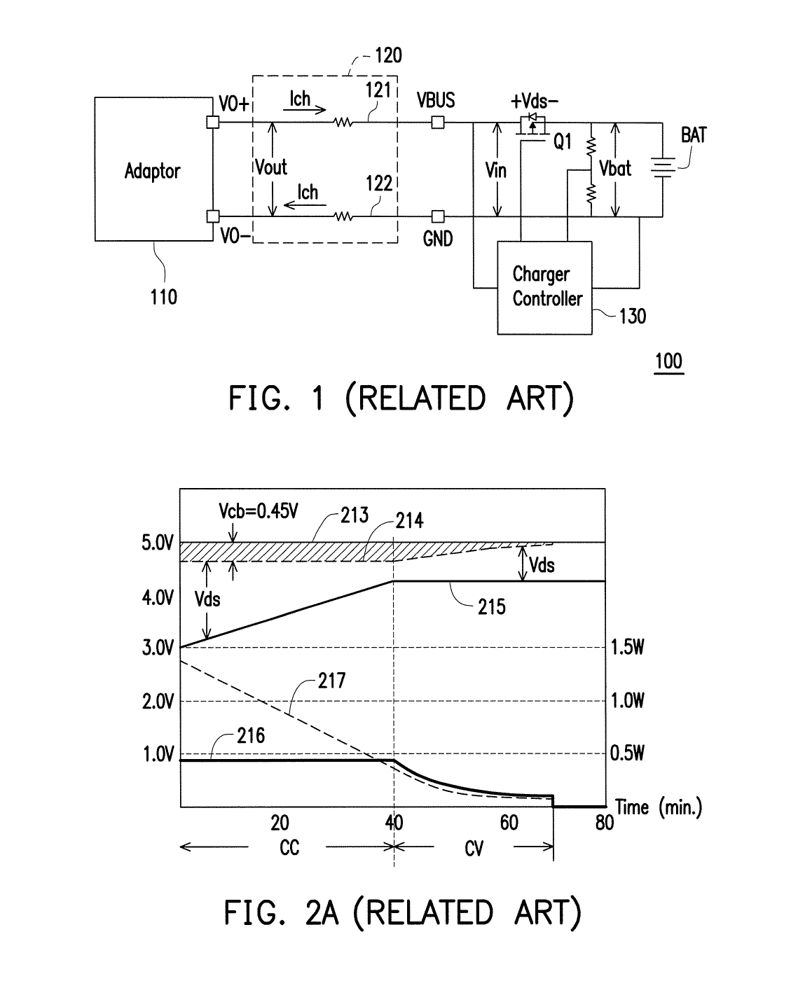

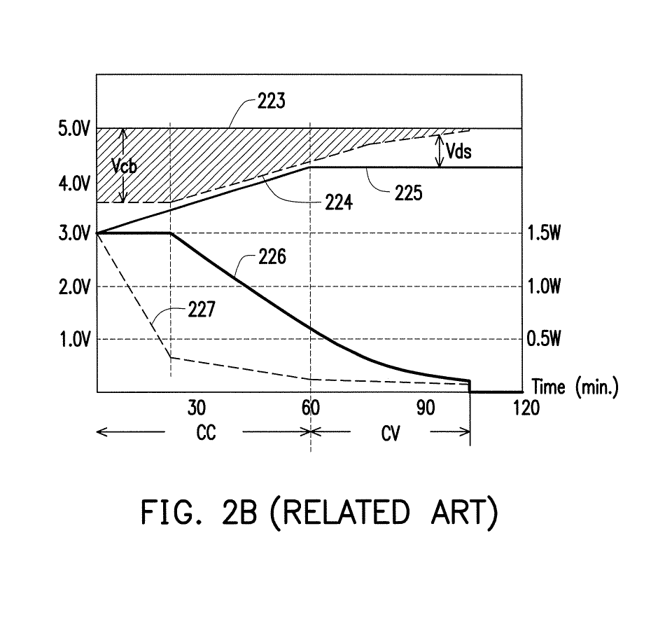

### DETAILED DESCRIPTION OF DISCLOSED EMBODIMENTS

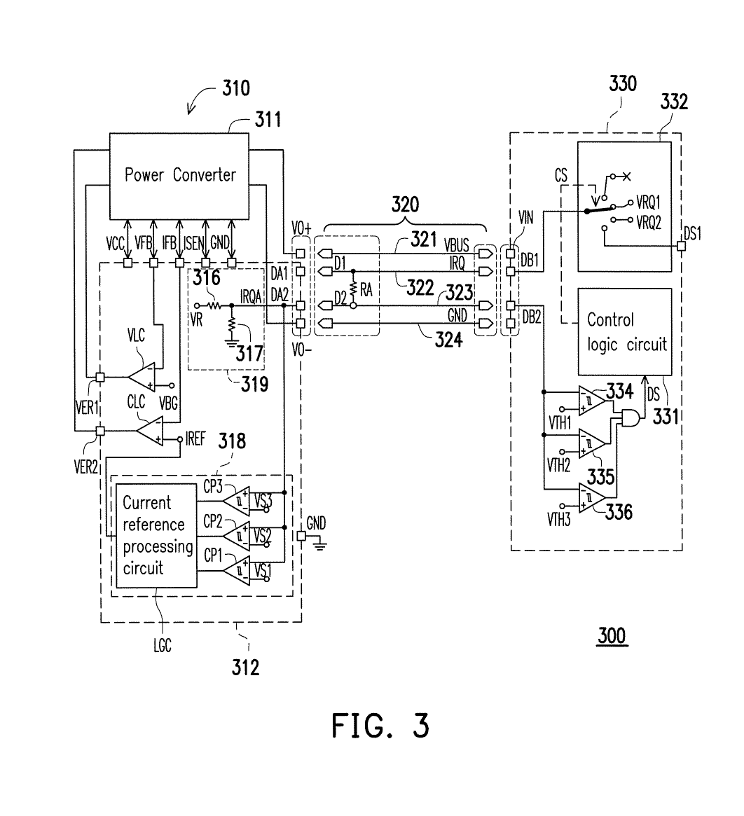

Please refer to FIG. 3, which illustrates a schematic diagram of a charger system according to an embodiment of the present disclosure. The charger system 300 includes a power adapter 310, a transmission cable 320 and a charger 330. The power adapter 310 includes a power converter 311 and a feedback control circuit 312. The power converter 311 may be a flyback converter. The power converter 311 receives an input voltage, and performs a voltage converting operation on the input voltage to generate an output voltage according to a first error voltage VER1, wherein the first error voltage VER1 is generated according to a feedback voltage VFB. The feedback control circuit 312 includes a current reference processing circuit 318, a voltage loop circuit VLC, a current loop circuit CLC, and a two-way voltage divider 319. In this embodiment, the processing circuit 318 receives a current request signal IRQA and compares the current request signal IRQA with a plurality of setting voltages VS1-VS3 to generate a reference current signal IREF. In detail, the processing circuit 318 includes a plurality of comparators CP1-CP3, and a processing logic circuit LGC. The comparators CP1-CP3 respectively receive the setting voltages VS1-VS3, and commonly receive the current request signal IRQA. By respectively compare the setting voltages VS1-VS3 with the current request signal IRQA, the comparators CP1-CP3 generate a plurality of comparison results. The processing logic circuit LGC receives the comparison results from the comparators CP1-CP3 and generates the reference current signal IREF according to the comparison results. In this embodiment, the current request signal IRQA may be received by a data pin DA2.

The two-way voltage divider 319 has two ends, a first end receives a second reference voltage VR, and a second end of the two-way voltage divider 319 is coupled to the data pin DA2 to receive the current request signal. The two-way voltage divider 319 includes resistors 316 and 317. In a standby mode, the two-way voltage divider 319 receives only the second reference voltage VR and uses the resistors 316 and 317 to generate a default voltage level on data pin DA2. This default voltage level serves to identify the adapter's output current capacity, such as mid-power (3.0 A) or high-power (5.0 A). In a communication mode, the two-way voltage divider 319 receives a current request signal through the data pin DA2 from the compliant charger 330.

The voltage loop circuit VLC and the current loop circuit CLC respectively generate the first error signal VER1 and a second error signal VER2. Herein, the current loop circuit CLC generates the second error signal VER2 according to the current reference signal IREF and an output current signal IFB from the power converter. The voltage loop circuit VLC generates the first error signal VER1 according to a feedback voltage VFB (a divided voltage of the output voltage) and a first reference voltage VBG.

In a standby mode, the default voltage level (e.g. 0.5V for a high-power adapter; 0.3V for a mid-power adapter), is set up by the second reference voltage VR (e.g. 1.0V for a high-power adapter; 0.6V for a mid-power adapter) and the two-way voltage divider 319. However, in a communication mode, the voltage of the current request signal IRQA may also be adjusted by the transmission cable 320 and the charger 330. Herein, the transmission cable 320 has a power wire 321, a ground wire 324, a first data wire 322 and a second data wire 323. If the transmission cable 320 is a compliant cable to the power adapter 310, a resistor RA is coupled between the first data wire 322 and the second data wire 323. That is, a current request signal IRQ can be transported from the data pin D1 through the resistor RA to the data pin D2 of the transmission cable 320, wherein the data pin D2 is coupled to the data pin DA2 of the power adapter 310. In a communication mode, the current request signal IRQA is adjusted according to the current request signal IRQ.

On the other hand, if the transmission cable 320 is not a compliant cable to the power adapter 310, the current request signal IRQ will fail to transport to the data pin D2. Such that, the current request signal IRQA is merely the default voltage level determined by the second reference voltage VR and resistors 316 and 317 of the two way voltage divider 319.

Further, if the charger 330 is a compliant charger to the power adapter 310, the charger 330 may include a control logic circuit, 331, a multiplexer circuit, 332, and three comparators 334-336. The control logic circuit 331 constantly monitors the battery voltage, the Vin voltage, and the voltage on a data pin DB2. The multiplexer circuit 332 couples to the data pin DB1, which couples to the first data wire 322. The multiplexer circuit 332 receives a control signal CS generated by the control logic circuit 331, and determines the data pin DB1 to be connected to a first pull-up voltage VRQ1 for a mid-power battery, or to be connected to a second pull-up voltage VRQ2 for a high-power battery, or to be floated, or to be connected to a data pin DS1. Such that, the current request signal IRQ may be equal to the pull-up voltages VRQ1, VRQ2, floating or bypassed to data pin DS1.

The control logic circuit 331 determines the presence of a qualified power source by checking the voltage Vin is indeed between 4.5V and 5.5V. At the detection of a qualified power source, the control logic circuit 331 will direct the charger 330 to enter a standby mode, and direct the multiplexer 332 to float the current request signal IRQ. During the standby mode, the control logic circuit 331 will use the three comparators to check the default voltage level on DB2, which is coupled to the second data wire 323. If the power source (the adapter 310) is a compliant adapter, then the voltage on the pin DB2 will be the default voltage level (e.g. 0.5V for a compliant high-power adapter; 0.3V for a compliant mid-power adapter). Three threshold voltages VTH1 to VTH3, may be set up to confirm the presence of a compliant adapter. For example, VTH1=0.2V, VTH2=0.4V, VTH3=0.6V. Therefore, if the voltage on the data pin DB2 is between the threshold voltages VTH1 and VTH2, the control logic circuit 331 will recognize the power source as being a compliant mid-power adapter. If the voltage on the data pin DB2 is between the threshold voltages VTH2 and VTH3, the control logic circuit 331 will recognize the power source as being a compliant high-power adapter. Otherwise, if the voltage on the data pin DB2 voltage is either higher than the threshold voltage VTH3 or lower than the threshold voltage VTH1, then the power source is recognized as a non-compliant power source, meaning it is either a conventional 5V, 1 A adapter or a standard down-stream port (SDP). At the end of the standby mode, the control logic circuit 331 will send a control signal CS to the multiplexer 332. Herein, if the power source is a compliant mid-power adapter, the control signal CS will guide the multiplexer 332 to connect data pin DB1 to the first pull-up voltage VRQ1. Then, this first pull-up voltage VRQ1 will be transported via the first data wire 322 to data pin D1, where it crosses over to data pin D2 if the transmission cable is a compliant cable with a bridging resistor RA. Therefore, the current request signal IRQA will be adjusted by the first pull-up voltage VRQ1. For example, if the resistors 316, 317 equals to 300 kΩ each, the bridging resistor RA=150 kΩ, the second reference voltage VR=0.6V, and the first pull-up voltage VRQ1=1.2V, then the current request signal IRQA will be 0.75V. The processing circuit 318 of the compliant mid-power adapter 310 will recognize the current request signal IRQA is between the setting voltage VS1 (=0.65V) and the setting voltage VS2 (=1.0V), and set a reference current IREF to a mid-power charging rate (e.g. 1.2V).

Whereas, if the power source is a compliant high-power adapter, the control signal CS will guide the multiplexer 332 to connect data pin DB1 to the second pull-up voltage VRQ2 (e.g. 2.0V) when the charger system 300 prefers a high-power charging rate. In this case, the IRQA voltage will be adjusted by the second pull-up voltage VRQ2 to 1.25V. Then the processing circuit 318 of the compliant high-power adapter 310 will recognize the current request signal IRQA voltage is between the setting voltages VS2 (=1.0V) and VS3 (=1.5V), and set the reference current IREF to a high-power charging rate (e.g. 2.0V). But if the charger system prefers a mid-power charging rate, it can guide the multiplexer 332 to connect data pin DB1 to the first pull-up voltage VRQ1 (1.2V). In this case, the current request signal IRQA voltage will be adjusted by the first pull-up voltage VRQ1 to 0.85V. The reference current IREF is still set to a mid-power charging rate (=1.2V).

Whereas, if the transmission cable is not a compliant cable, there will be no bridging resistor RA. Therefore, the first pull-up voltage VRQ1 or the second pull-up voltage VRQ2 will not be connected to data pin DA2, and current request signal IRQA will remain at the default voltage level (e.g. 0.3V for a mid-power adapter, or 0.5V for a high-power adapter), and the processing circuit 318 of the compliant adapter will set IREF to a standard charging rate (e. g. 0.4V).

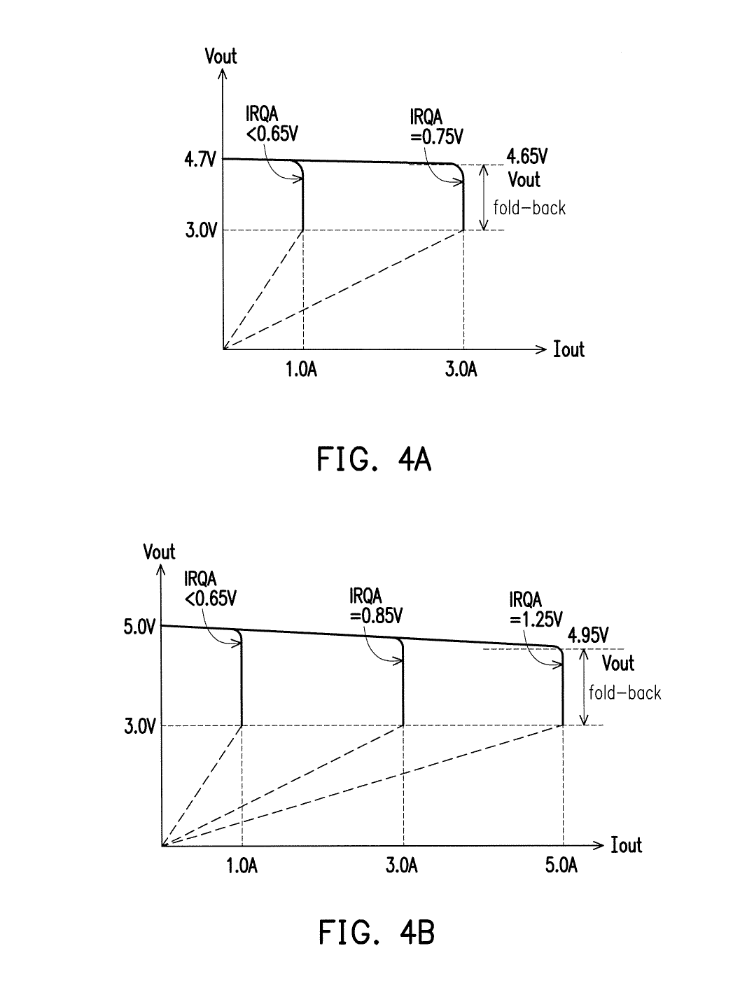

Please refer to FIG. 4A and FIG. 4B, which illustrate the characteristics of the power adapter according to an embodiment of the present disclosure. In FIG. 4A, the power adapter may have two selectable current limit levels, 1.0 A (standard charging rate) and 3.0 A (mid-power charging rate). When the power adapter detects the current request signal IRQA signal of 0.75V level (more specifically, between 0.65V and 1.0V), the output voltage Vout of the power adapter may be regulated in the range of (4.7V, 4.65V) for load current from 0.0 A to 3.0 A. But if the load current demand is trying to exceed 3.0 A, the output voltage Vout will drop (i.e. fold back) from 4.65V toward an operating voltage level Vop, which is determined by: Vop=Vbat+3.0A*(Rcb+Rds−on), where Vbat is the battery voltage, Rcb is the transmission cable power loop DC resistance. Rds-on is the conduction resistance of the transistor (Q1) of the charger when it is turned on completely.

Whereas, if the power adapter detects the current request signal IRQA of less than 0.65V, its output voltage will fold back when the load current demand tries to exceed 1.0 A.

Similarly, in FIG. 4B, there are three selectable current limit levels for the power adapter's output voltage fold-back: 1.0 A, 3.0 A, and 5.0 A (high-power charging rate). When the power adapter detects the current request signal IRQA of 1.25V level (more specifically, between 1.0V and 1.5V), the power adapter's output voltage Vout may be regulated in the range of (5.0V, 4.95V) for load current from 0.0 A to 5.0 A. But if the load current demand is trying to exceed 5.0 A, the output voltage Vout will fold back from 4.95V toward an operating voltage level Vop, which is determined by:

Vop=Vbat+5.0A*(Rcb+Rds−on).

Whereas, if the power adapter detects the current request signal IRQA of 0.85V level, the power adapter's output voltage will fold back at a current limit level of 3.0 A. Whereas, if the power adapter detects the current request signal IRQA of less than 0.65V, the power adapter's output voltage will fold back at a current limit level of 1.0 A.

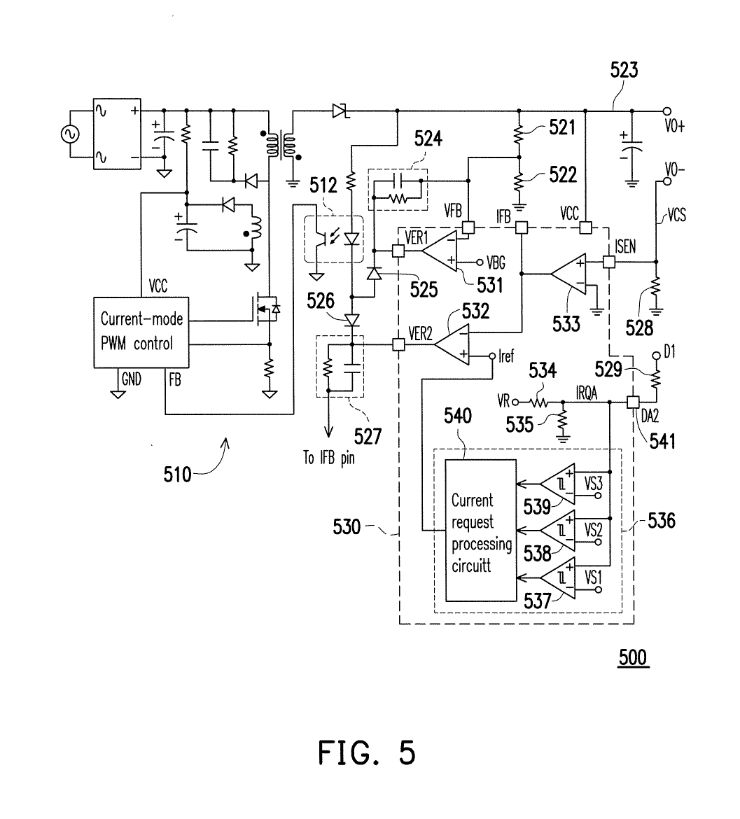

Please refer to FIG. 5, which illustrates a schematic diagram of a power adapter according to an embodiment of the present disclosure. The power adapter 500 includes a power converter 510 and a feedback control circuit 530. The power converter 510 is a flyback converter and may be implemented by a conventional flyback converter known by a person skilled in the art. The feedback control circuit 530 includes a voltage loop circuit 531 (formed by an operation amplifier), a current-loop circuit 532 (formed by another operation amplifier), a current sense resistor 527 (e.g. 20 mΩ), a voltage multiplier 533, which multiplies the current sensing voltage ISEN across resistor 527 by a factor of N (e.g. N=20). The feedback control circuit 530 also includes a processing circuit 536, and a DA2 pin 541. The processing circuit 536 includes three comparators 537, 538, and 539, and a processing logic circuit 540. The DA2 pin 541 is for receiving a current request signal IRQA, which has a default value of 0.3V for a mid-power adapter, setting up by a 0.6V reference voltage VR and a voltage dividing circuit formed by resistors 534 and 535. This current request signal IRQA of 0.3V level is discerned by comparator 539, which informs the processing logic circuit 540 to produce the reference current signal IREF level of 0.4V, for the current loop circuit 532. Therefore, in the case that the data pin DB1 is open, or the bridging resistor 529 provided by a transmission cable is missing (as in the case of a non-compliant USB cable being connected), the power adapter will operate with a default current limit of 1.0 A.

If a compliant charger couples a current request signal IRQ of 1.2V to the data pin D1, and if the transmission cable coupled to the power adapter 500 is compliant (0.1 ohm power-loop resistance), the voltage of the current request signal IRQA on the data pin DA2 will be shifted to 0.75V. The comparators 538 and 539 discern the current request signal IRQA of 0.75V level, and inform the processing logic circuit 540 to produce a reference current signal IREF level of 1.2V. The power adapter 500 then operates with a selected current limit of 3.0 A.

It should be noted that, a voltage dividing circuit formed by the divider resistor pair (resistors 521 and 522) senses and couples the output voltage 523 to the inverted input pin of the voltage loop circuit 531. Another input pin of the voltage loop circuit 531 receives a first reference voltage VBG (e g. 2.0V). A first compensation network 524 provides a suitable feedback compensation for the voltage-loop regulation to achieve stability and fast response speed. Similarly, a current sensor circuit including the current sense resistor 528 senses the output current lout. The induced voltage Vcs is determined as Vcs=Iout*R528=Iout*20 mohm, where R528 is resistance of the current sense resistor 528. The current sensor circuit further includes a voltage multiplier 533. The induced voltage Vcs is multiplied by a factor of 20 by the voltage multiplier 533. A compensation network 527 provides a suitable feedback compensation for the current-loop regulation. Further, the same secondary-side controller 530 can be applied to implement a high-power (e.g. 5.0 A) compliant adapter with minor modifications.

Furthermore, there is an additional comparator 537, to discern a high-power (e.g. 5.0 A) current limit request. If there is a high-power compliant charger requesting a 5.0 A current limit, it may couple a 2.0V current request signal IRQ to the data pin D1. Therefore, the voltage of the current request signal IRQA on the data pin DA2 will be shifted to 1.25V level. The comparators 537 and 538 discern this 1.25V voltage level, and inform the processing logic circuit 540 to produce a reference current signal IREF signal of 2.0V. The compliant high-power adapter then operates with a selected current limit of 5.0 A. For any noncompliant charger or non-compliant transmission cable (without a necessary bridging resistor), this compliant high-power adapter will operate at a default current limit level of 1.0 A. For a compliant 3 A charger, this compliant high-power adapter will respond to a 3.0 A current limit request if a 1.2V IRQ current request signal is received.

Furthermore, the voltage loop circuit 531 and the current loop circuit 532 respectively generate the first and second error signals VER1 and VER2. The first and second error signals VER1 and VER2 are respectively further coupled to cathodes of diodes 525 and 526. The anodes of diodes 525 and 526 are coupled together, and coupled to the opto-coupler 512 for providing the error voltage to the primary-side of power converter 510.

In this embodiment, the resistors 534 and 535 form a two-way voltage divider, whose function is the same as that of two-way voltage divider 319 in FIG. 3.

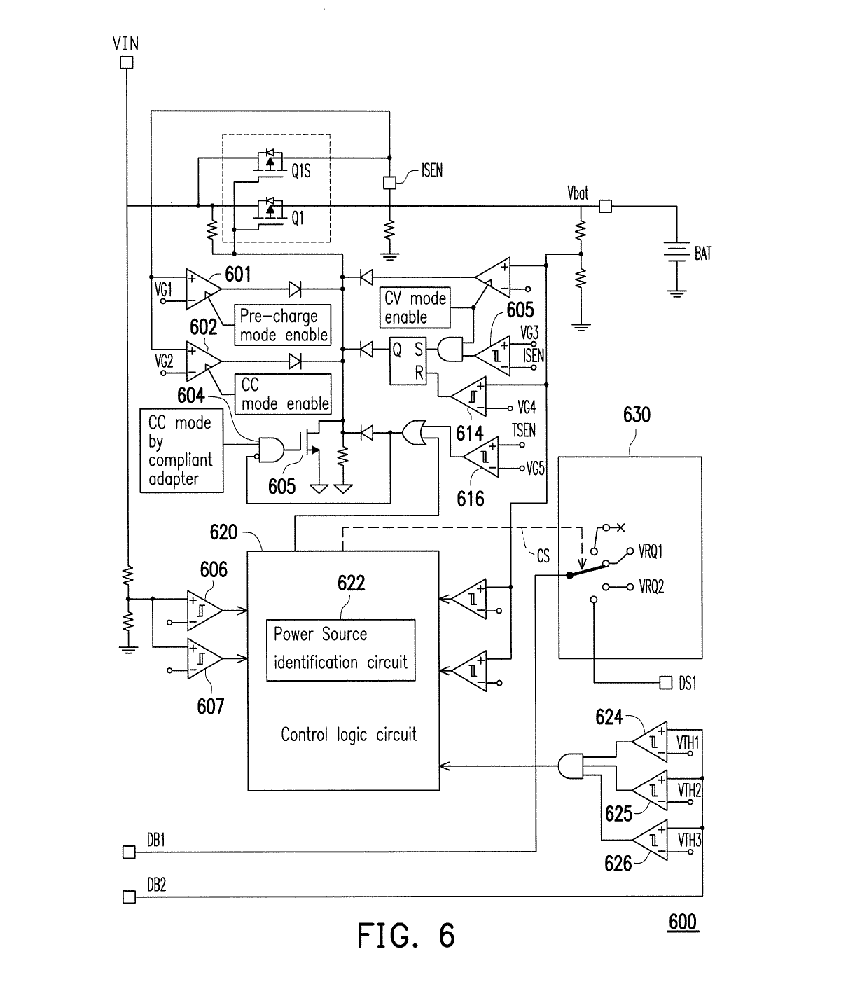

Please refer to FIG. 6, which illustrates a schematic diagram of a charger according to an embodiment of the present disclosure. In this embodiment, similar to a conventional internal linear charger, the charger 600 includes a pre-charge operational amplifier (OPA) 601 and a termination comparator 614 both having a reference voltage VG1 with a voltage level of 0.3V, corresponding to a pre-charge current of 0.3 A, as well as a termination threshold level of 0.3 A. The pre-charge operational amplifier (OPA) 601 and the termination comparator 614 both are referenced to a current sensing signal ISEN. Furthermore, an over-temperature comparator 616 is disposed in the charger 600. The over-temperature comparator 616 receives a temperature sensing signal TSEN for enabling an over temperature protection.

It should be noted here, for the charger 600 of the present embodiment, it relegates the constant current regulation in CC stage (3 A or 5 A) to a compliant adapter (such as the power adapter 500) when one is present. More precisely, a power source identification circuit 622 of the charger 600 recognizes the presence of a compliant adapter. Once a compliant adapter is detected, the charger 600 sends out the current request signal IRQ via a multiplexer circuit 630, and through a compliant transmission cable (USB cable), to the compliant adapter requesting a proper current limit level. During the CC stage, the control logic circuit 620, simply turns on the transistor Q1 completely by turning on a control transistor 605, thus forcing the compliant adapter to fold back its output voltage Vout at the requested current limit level.

Notice that an AND gate 604 is used to prevent the transistor 605 from turning on the transistor Q1, if there is an over temperature protection (OTP) shutdown or the charger 600 is in a standby mode. Notice also in FIG. 6, the transistor Q1S is a current mirror device coupled to the transistor Q1. In the FIG. 6 embodiment, a current mirror ratio of 1000:1 may be used.

On the other hand, when comparators 606 and 607 detects the presence of a qualified power source (Vin is between 4.5V and 5.5V), the control logic circuit 620 enters a standby mode, wherein the voltage on the data pin DB1 of the multiplexer 630 is floated. Then, the control logic circuit checks the voltage on the data pin DB2 using the three comparators 624-626. If the voltage on the data pin DB2 falls between 0.2V and 0.4V, then the power source is recognized as a compliant mid-power adapter. If the voltage on the data pin DB2 falls between 0.4V and 0.6V, then the power source is recognized as a compliant high-power adapter. Otherwise, if the voltage on the data pin DB2 is higher than 0.6V or lower than 0.2V, then the power source is recognized as an SDP (Standard Down-stream Port) or a non-compliant adapter. Therefore, during the CC stage, the charging current will be regulated to 0.9 A by the OPA 602 (by reference to a voltage VG2). Herein, the comparators 624-626 compare the voltage on the data pin DB2 with the threshold voltages VTH1, VTH2, and VTH3 respectively, where the threshold voltages VTH1, VTH2, and VTH3 may be 0.2V, 0.4V, and 0.6V respectively.

Furthermore, the control logic circuit 620 works with the multiplexer circuit 630, to send out a current request signal IRQ signal requesting a desired current limit level to a compliant adapter via the data pin DB1, which is coupled to the data pin D1 of the transmission cable.

The multiplexer circuit 630 is under the control of control logic circuit 620 according to a control signal CS. For a compliant mid-power adapter, the multiplexer circuit 630 couples a request voltage VRQ1 of 1.2V to the data pin DB1. For a compliant high-power adapter, the multiplexer circuit 630 couples a request voltage VRQ2 of 2.0V to the data pin DB1. Further, when no power source is present, or the power source is a non-compliant adapter or a SDP, the multiplexer circuit 630 couples the data pin DB1 to the data pin DS1, which may be a regular USB data pin D+ of an electronic apparatus hosting the charger 600.

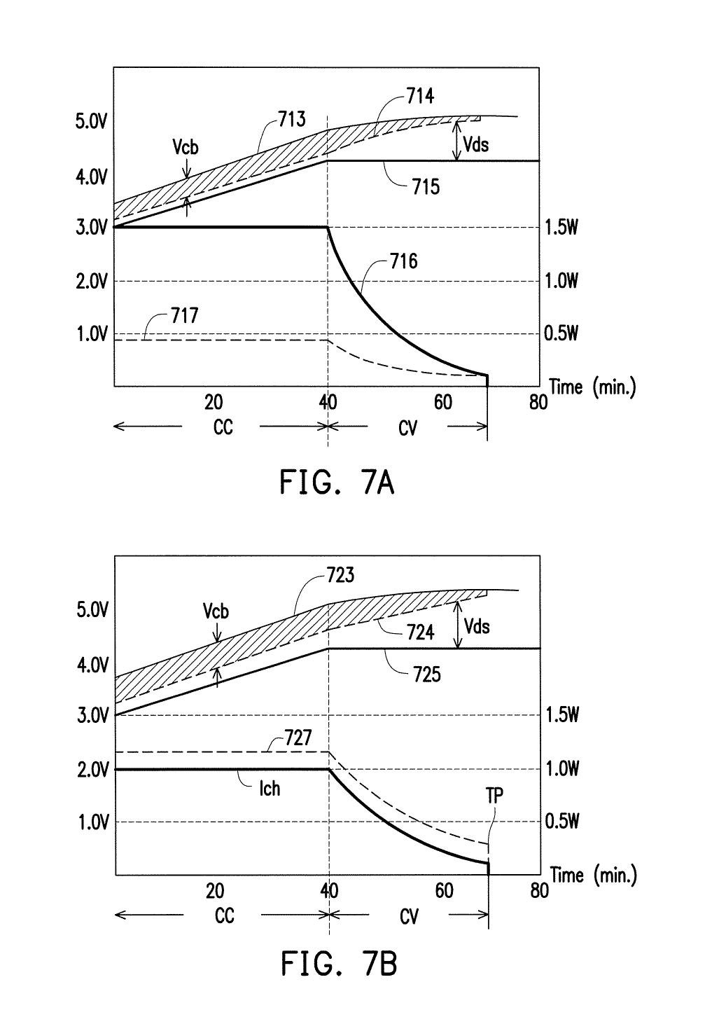

Please refer to FIG. 7A and FIG. 7B, which illustrate waveform plots of the charger system according to the FIG. 6 embodiment. In FIG. 7A, waveforms of a charger system using a 4.65V, 3.0 A compliant adapter to charge a 3.0 AH battery with a 3.0 A compliant charger are illustrated. During a constant current (CC) stage, with the transistor Q1 been turned on completely, the transistor Q1 appears to the power adapter as a resistance of Rds−on=0.05 ohm. Hence, the voltage drop Vds across the transistor Q1 is equal to, 3A*0.05 ohm=0.15V. Also, a voltage drop Vcb on a compliant 0.1 transmission cable of the charger system is equal to 0.3V during the CC stage. Therefore, as the Vbat voltage, shown as curve 715, increases from 3.0V to 4.2V during the CC stage, the Vin voltage maintains a difference of 0.15V above the Vbat voltage. The Vout voltage, shown as curve 713, is generated by the 3 A compliant adapter. Since the charger 600 of the charger system is trying to draw as much charging current as possible by turning on the transistor Q1 completely, the power adapter is forced to operate at the 3.0 A current limit level. Hence, the output voltage Vout of the power adapter folds back to Vbat+3A*(Rcb+Rds−on)=Vbat+0.45V during the CC stage.

The curve 717 shows the power dissipation of the transistor Q1, is at a constant 0.45 W level during the CC stage. As the charging current tapers off during a constant voltage (CV) stage, the power dissipation of the transistor Q1 also tapers off from 0.45 W to 0.18 W at the end of the CV stage. Notice, however, the power dissipation on compliant USB cable during the CC stage is at a constant 0.9 W level. Further, the power efficiency is 86.9% at the start of the CC stage (where the voltage Vbat=3.0V). It improves to 90.3% at the start of the CV stage (where the voltage Vbat=4.2V). The average efficiency during the CC stage is at 88.6%, a vast improvement over the 72% average efficiency of a conventional 1.0 A linear charger. FIG. 7A also includes a curve 716, which is the charging current Ich, flowing through the transmission cable. The curve 714 shows the VBUS voltage on the transmission cable 320 as in FIG. 3 used in this charger system.

In FIG. 7B, waveforms of a charger system using a 4.95V, 5.0 A compliant adapter to charge a 5.0 AH battery with a 5.0 A compliant charger are illustrated. The Vbat voltage shown as curve 725, increases from 3.0V to 4.2V during the CC stage. Since the sum of the voltage drop on the transmission cable and the voltage drop Vds of the transistor Q1 is 0.75V, the voltage Vout increases from 3.75V to 4.95V during the CC stage, as shown by curve 723. The charging current Ich maintains at 5 A level in the CC stage. After entering the CV stage, the charging current Ich starts to taper off. The curve 727 shows the power dissipation of the transistor Q1 is equal to 1.25 W throughout the CC stage. In the CV stage, the power dissipation of the transistor Q1 tapers off from 1.25 W to 0.3 W at the termination point.

It should be noted that, the power dissipation of the transmission cable of the charger system is constant at 2.5 W during the CC stage of this 5 A charger system. The power efficiency in the CC stage is 80% at the start of the CC stage, and is improved to 84.8% at the start of the CV stage. The average efficiency in the CC stage is 82.4%, still significantly better than the 72% average efficiency of a conventional 1.0 A linear charger system. But more importantly, the maximum Q1 dissipation in this 5.0 A compliant charger system, is only 1.25 W, lower than the 1.395 W of a conventional 1.0 A linear charger system. The curve 724 shows the VBUS voltage on the transmission cable 320 as in FIG. 3 used in this charger system.

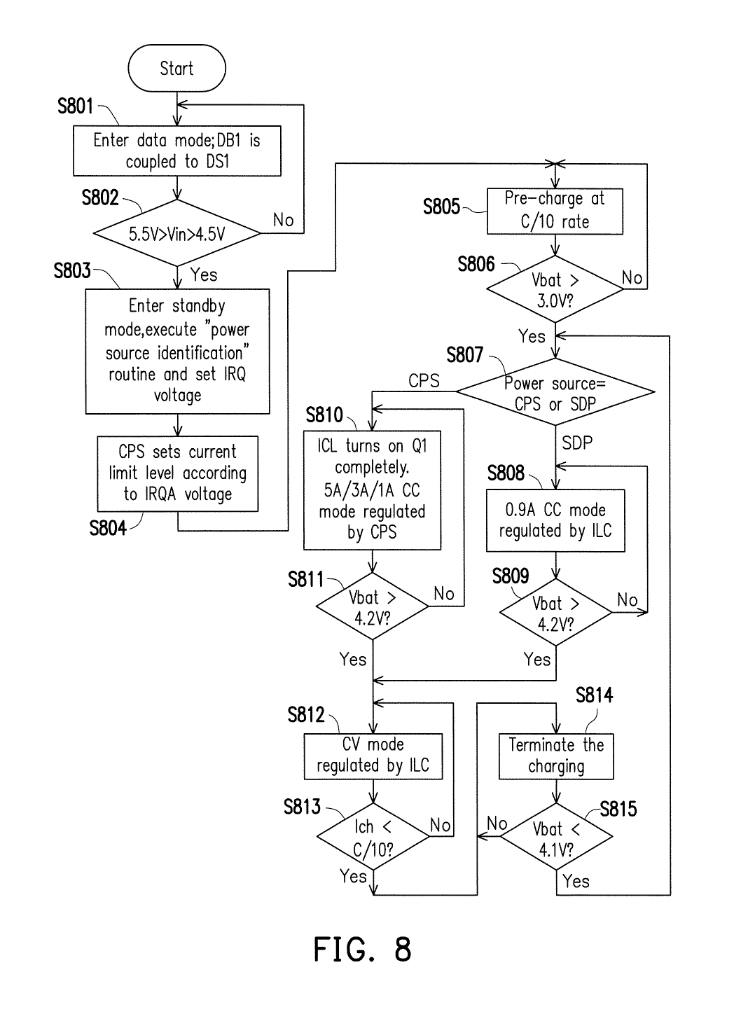

FIG. 8 shows the flowchart of operation of a charger system according to an embodiment of the present disclosure. Initially at step S801, a mobile phone charger system is in a data mode, where the energy stored in the battery powers the system load, main switch Q1 is turned off, and the multiplexer couples the data pin DB1 to the pin DS1. The charger (an internal linear charger, ICL) constantly monitors whether a qualified power source is present, as shown in step S802. If an external power source Vin with an output voltage within the range of 4.5V to 5.5V is present, then in step S803 the charger enters a standby mode, and executes a power source identification routine where it recognizes and marks the power source as an SDP (representing a conventional standard down-stream port or a non-compliant adapter), a mid-level (e.g. 3 Amp) compliant power source (CPS), or a high-level (e.g. 5 Amp) compliant power source. The ICL also sets the voltage of the current request signal IRQ by connecting data pin DB1 to the pull-up voltages VRQ1 or VRQ2 when a CPS is present.

Next, in step S804, the power source, if it is a CPS, will check whether the current request signal IRQA voltage has been pulled up by the voltage of the current request signal IRQ which is coupled to the pull-up voltages VRQ1 or VRQ2. If that is the case, the CPS will set its current limit according to the adjusted current request signal IRQA. In step S805, the charger starts a charging process by entering the pre-charge mode, where the charging current is regulated by the charger to C/10 rate. During the precharge mode, the charger constantly checks whether the Vbat voltage has risen above 3.0V level in step S806. Once the Vbat voltage exceeds 3.0V, the charger enters a different CC stage depending on the type of power source and the requested charging current limit. For an SDP, the charger enters step S808 where the charging current in the CC mode is regulated at 0.9 A by the ICL's control circuit. For a CPS, the ICL control circuit simply turns on the transistor Q1 completely, allowing a CC mode whose charging current is regulated by the CPS at the requested current limit level (e.g. 1 A, 3 A, or 5 A), as shown in step S810. During the CC mode, the ICL constantly checks the Vbat voltage in step S809 or in step S811. As soon as the Vbat voltage exceeds the CV mode threshold level (e.g. 4.2V), the ICL will exit the CC mode and enter the CV mode, as shown in step S812. During the CV mode, the ICL constantly checks whether the charging current has dropped below C/10 level in step S813. Once the charging current drops below C/10 level, the ICL enters the termination stage in a step S814. During the termination stage, the ICL constantly checks whether the voltage Vbat has dropped below a re-charge level (e.g. 4.1V) in step S815. Once the voltage Vbat drops below recharge level in the termination mode, the ICL returns to step S807 to recharge the battery.

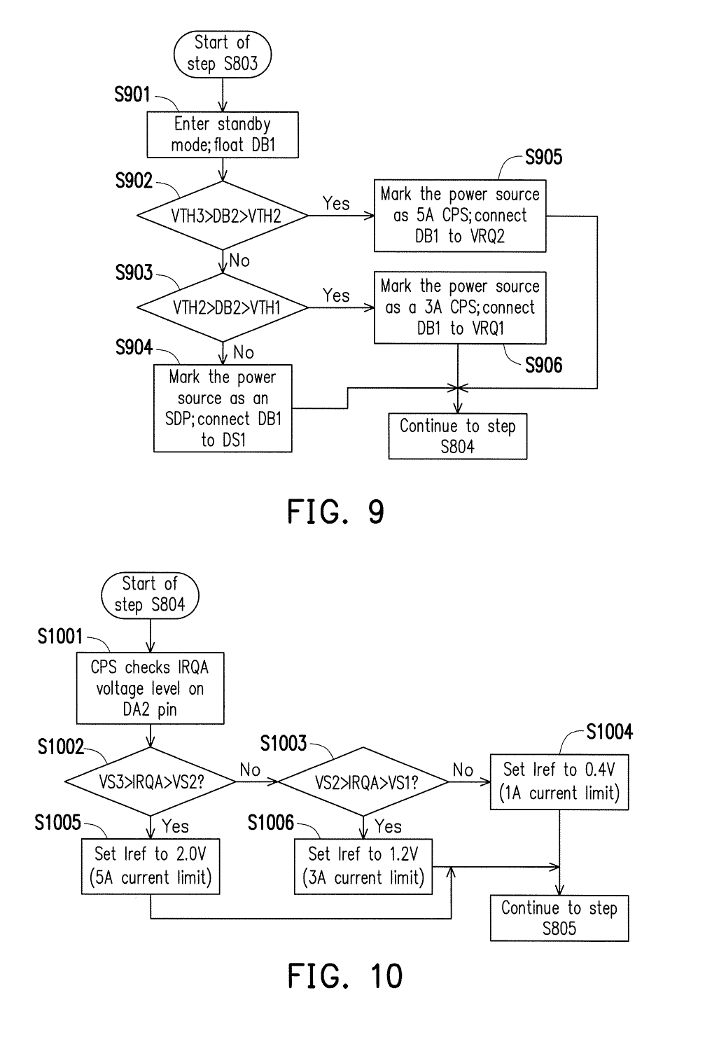

Please referring to FIG. 9, which shows the power source identification routine of step S803 according to the embodiment in FIG. 8 of the present disclosure. In step S901, the ICL first enters the standby mode, where the voltage on the data pin DB1 is floated. Then the ICL checks the voltage on the data pin DB2 in steps S902 and S903. If the voltage on the data pin DB2 is between the threshold voltages VTH3 (0.6V) and VTH2 (0.4V), the power source is recognized and marked as a high-level (e.g. 5 A) compliant power source. Then the ICL couples the data pin DB1 to the pull-up voltage VRQ2 (e.g. 2.0V), as shown in step S905. But if the voltage on the data pin DB2 is between the threshold voltages VTH2 (0.4V) and VTH1 (0.2V), the power source is recognized and marked as a mid-level (e.g. 3 A) compliant power source. Then the ICL couples the data pin DB1 to a pull-up voltage VRQ1 (e.g. 1.2V), as shown in step S906. Otherwise, if the voltage on the data pin DB2 is higher than the threshold voltage VTH3 or lower than the threshold voltage VTH1, the power source is recognized and marked as an SDP. Then the ICL couples the data pin DB1 to the pin DS1, as shown in step S904. Afterwards, steps S904, S905, and S906 all continue to step S804. Please refer to FIG. 10, which shows the CPS reaction to the step S804 of the ICL according to the embodiment in FIG. 8 of the present disclosure. In step S1001, the CPS checks the voltage level of the current request signal IRQA on the data pin DA2. If in step S1002, the IRQA voltage is found to be between VS2 (e.g. 1.0V) and VS3 (e.g. 1.5V), the CPS recognizes the ICL is requesting a high-level or 5 A current limit. Then the CPS sets a reference current signal IREF to 2.0V, corresponding to a 5.0 A current limit in step S1005. If in step S1003, the current request signal IRQA voltage is found to be between VS1 (e.g. 0.65V) and VS2 (e.g. 1.0V), the CPS recognizes the ICL is requesting a 3 A current limit. Then the CPS sets the reference current signal IREF to 1.2V, corresponding to a 3.0 A current limit in step S1006. Otherwise, if the voltage of the current request signal IRQA falls outside of the setting voltages VS1 to VS3 range, the CPS treats the situation as owing to a non-compliant ICL (which is incapable of sending the current request signal IRQ), or a non-compliant USB cable (which is without a bridging resistor), and sets the reference current signal IREF to 0.4V, corresponding to a 1.0 A current limit in step S1004. Afterwards, steps S1004, S1005, and S1006 all continue to step S805.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. A power adapter, having a plurality of output current limit levels, comprising:
a power converter, receiving an input voltage, performing a voltage conversion on the input voltage to generate an output voltage according to an operating error voltage; and
a feedback control circuit, coupled to the power converter, comprising:
a current reference processing circuit, having a plurality of setting voltages, receiving a current request signal and comparing the current request signal with the plurality of setting voltages to generate a reference current signal;
a voltage loop circuit, generating a first error voltage according to a divided output voltage and a first reference voltage; and
a current loop circuit, generating a second error voltage according to an output current signal from the power converter and the reference current signal,
wherein, the operating error voltage is determined by either the first error voltage or the second error voltage, whichever has a lower voltage level.

2. The power adapter as claimed in claim 1, wherein the reference current signal selects one of the plurality of current limit levels.

3. The power adapter as claimed in claim 2, wherein the output voltage of the power adapter folds back if the output current of the power adapter reaches a selected current limit level.

4. The power adapter as claimed in claim 3, wherein the current reference processing circuit comprises:
a data pin;
a plurality of comparators, respectively receiving the setting voltages, and the comparators commonly receiving the current request signal, respectively generating a plurality of comparison results; and
a current request processing circuit, coupled to the comparators, operating on the comparison results to generate the reference current signal.

5. The power adapter as claimed in claim 4, wherein the current reference processing circuit coupled to the data pin for receiving the current request signal.

6. The power adapter as claimed in claim 1, wherein the current loop circuit comprises:
a current sensor circuit, sensing the output current of the power adapter, and providing an output current signal;
a first operational amplifier, having a first input end coupled to the current sensor circuit for receiving the said output current signal, a second input end for receiving the reference current signal, and an output end for generating the second error voltage.

7. The power adapter as claimed in claim 1, wherein the voltage loop circuit comprises:
an output voltage divider, having a first end coupled to the positive output end of the power adapter, a second end coupled to the reference ground, and a third end for generating the said divided output voltage;
a second operation amplifier, having a first input end coupled to the third end of the output voltage divider circuit for receiving the divided output voltage, a second input end for receiving the said first reference voltage, and an output end for generating the first error voltage.

8. The power adapter as claimed in claim , wherein the current sensor circuit further comprises:
a current sense resistor, having a first end coupled to the negative output end of the power adapter, a second end coupled to the reference ground;
a voltage multiplier, having a first input end coupled to the first end of the current sense resistor, a second input end coupled to the reference ground, and an output end for generating the said output current signal.

9. A charger system, comprising:
a power adapter as claimed in claim 3, further comprises:
a two-way voltage divider for receiving a second reference voltage through a first input end and dividing the second reference voltage to generate a default voltage level, and for receiving the current request signal through a second input end to generate a current request level signal;
an enhanced USB cable, coupled to the power adapter for transmitting the adapter output voltage; and
a charger, having a input voltage pin, a ground pin, a first data pin and a second data pin, wherein, the input voltage pin and ground pin coupled to the enhanced USB cable for receiving the adapter output voltage; wherein, the first data pin coupled to the enhanced USB cable for transmitting a current request signal, the second data pin for receiving the adapter default voltage level,
wherein, the power adapter identifies whether the enhanced USB cable is a compliant cable or not, and identifies whether the charger is a compliant charger or not according to the presence of the current request signal.

10. The charger system as claimed in claim 9, wherein the power adapter folds back the output voltage at the selected current limit level according to the charger current request signal.

11. The charger system as claimed in claim 9, wherein the enhanced USB cable comprises:
a power wire, being configured to transmit the adapter output voltage and to carry the charging current to the charger;
a ground wire, being configured to carry the returning charging current;
a first data transmission wire, having a first end coupled to the first charger data pin, and a second end; and
a second data transmission wire, having a first end coupled to the second charger data pin, a second end coupled to the adapter data pin.

12. The charger system as claimed in claim 11, wherein the enhanced USB cable further comprises:
a bridging resistor; coupled between the second end of the first data transmission wire and the second end of the second data transmission wire.

13. The charger system as claimed in claim 9, wherein the charger further comprises:
a multiplexer circuit, having a plurality of request voltages, coupled to the first data pin, and selecting one of the plurality of request voltages to generate the current request signal according to a select signal;
a comparing circuit, coupled to the second data pin, receiving the adapter default voltage level on the second data pin, and comparing the adapter default voltage level on the second data pin with three threshold voltages to generate a detection signal; and
a control logic circuit, coupled to the comparing circuit and the multiplexer circuit, generating the select signal according to the detection signal.
